(19) United States
(12) Patent Application Publication
(10) Pub. No.: US 2005/0011314 A1
(43) Pub. Date: Jan. 20, 2005

(54) RATCHET MECHANISM FOR RATCHET DRIVING TOOL

(76) Inventor: Jeff Chen, Taichung (TW)

Correspondence Address: Jeff Chen, P.O. Box 63-99, Taichung, 406, TW

(21) Appl. No.: 10/624,971

(22) Filed: Jul. 18, 2003

(51) Int. Cl. B25B 13/46

(52) U.S. Cl. 81/63

(57) ABSTRACT

A ratchet driving tool includes a handle having a chamber formed in a head, a peripheral flange extended into the chamber to form an opening of a reduced inner diameter. A ratchet wheel is rotatably received in the head and includes a swelling rotatably engaged in the opening of the head to stably retain the ratchet wheel within the head. A retaining ring is engaged with the ratchet wheel to stably retain the ratchet wheel within the head. The handle includes a space to receive an actuator secured to the handle with another retaining ring, and includes a compartment to receive a pawl which may determine the rotational direction of the ratchet wheel.

### BACKGROUND OF THE INVENTION

1. Field of the Invention

The present invention relates to a ratchet tool, and more particularly to a ratchet driving tool having a simplified structure for facilitating the manufacturing and assembling of the ratchet driving tool.

2. Description of the Prior Art

Various kinds of typical ratchet driving tools have been developed and comprise a toothed driven member rotatably received in a head that is normally formed and provided on one end of a handle. A pawl is further provided and engaged within the head or the handle, and actuated or moved by an actuating member, in order to control or to change the driving directions of the ratchet driving tools.

One example of the typical ratchet driving tools has been disclosed in U.S. Pat. No. 6,260,449 to I-He, and also comprises a pawl actuated or moved by an actuating member, in order to engage with the toothed driven member, and so as to control or to change the driving directions of the ratchet driving tools.

However, a cover is required to be engaged onto the head and the handle, and engaged with the pawl and the actuating member and the toothed driven member, in order to retain the pawl and the actuating member and the toothed driven member within the head and/or the handle after the pawl and the actuating member and the toothed driven member have been engaged into the head and/or the handle.

The users or the workers are required to simultaneously depress the pawl and the actuating member and the toothed driven member within the head and/or the handle, before the cover may be suitably engaged onto the head and the handle, and to retain the pawl and the actuating member and the toothed driven member within the head and/or the handle

The present invention has arisen to mitigate and/or obviate the afore-described disadvantages of the conventional ratchet driving tools.

### SUMMARY OF THE INVENTION

The primary objective of the present invention is to provide a ratchet driving tool including a simplified structure for facilitating the manufacturing and assembling of the ratchet driving tool.

In accordance with one aspect of the invention, there is provided a ratchet driving tool comprising a handle including a head provided on one end thereof, the head including a chamber formed therein, and including an upper portion having a peripheral flange extended into the chamber thereof to form an opening therein which includes an inner diameter smaller than that of the chamber of the head, the head including an inner peripheral groove formed therein and communicating with the chamber thereof, a ratchet wheel rotatably received in the chamber of the head, and including a plurality of teeth provided thereon, and including a swelling extended therefrom and rotatably engaged in the opening of the head to stably retain the ratchet wheel within the chamber of the head, a retaining ring engaged in the inner peripheral groove of the head, and engaged with the ratchet wheel, and to stably and rotatably retain the ratchet wheel within the chamber of the head. The handle includes a space formed therein and having an open upper portion and having a lower portion, and a peripheral rib extended into the lower portion of the space of the handle, to form an orifice therein, the orifice including an inner diameter smaller than that of the space and the open upper portion of the space of the handle. An actuator is rotatably received in the space of the handle, and includes a lower portion having an outer peripheral shoulder formed therein to receive the peripheral rib of the handle, and to form a circular bulge which is rotatably engaged into the orifice of the handle, to rotatably retain the actuator within the space of the handle, the actuator includes a hand grip provided on top thereof for rotating the actuator relative to the handle. The head includes a compartment formed therein and formed between the chamber of the head and the space of the handle, and having two narrower ends provided therein, a pawl is slidably received in the compartment of the head, and includes a plurality of teeth for engaging with the teeth of the ratchet wheel, and includes a depression formed therein, the actuator includes a cavity formed therein, and a spring-biased detent is received in the cavity of the actuator, and engaged within the depression of the pawl, to force the pawl to either of the narrower ends of the compartment of the head, when the actuator is rotated relative to the handle with the hand grip of the actuator.

The actuator includes a notch formed therein and communicating with the cavity thereof to partially receive the pawl. The actuator includes a spring received in the cavity thereof to engage with and to bias the detent to force the pawl to either of the narrower ends of the compartment of the head.

The actuator includes an upper portion having an inner peripheral recess formed therein, and a second retaining ring engaged in the inner peripheral recess of the actuator, and engaged with the handle, to stably retain the actuator within the space of the handle.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is an exploded view of a ratchet driving tool in accordance with the present invention;

FIG. 2 is a partial perspective view of the ratchet driving tool, in which a portion of the ratchet driving tool has been cut off to show the inner structure of the ratchet driving tool;

FIG. 3 is a partial top plan view of the ratchet driving tool; and

FIG. 4 is a partial cross sectional view of the ratchet driving tool, taken along lines 4-4 of FIG. 3.

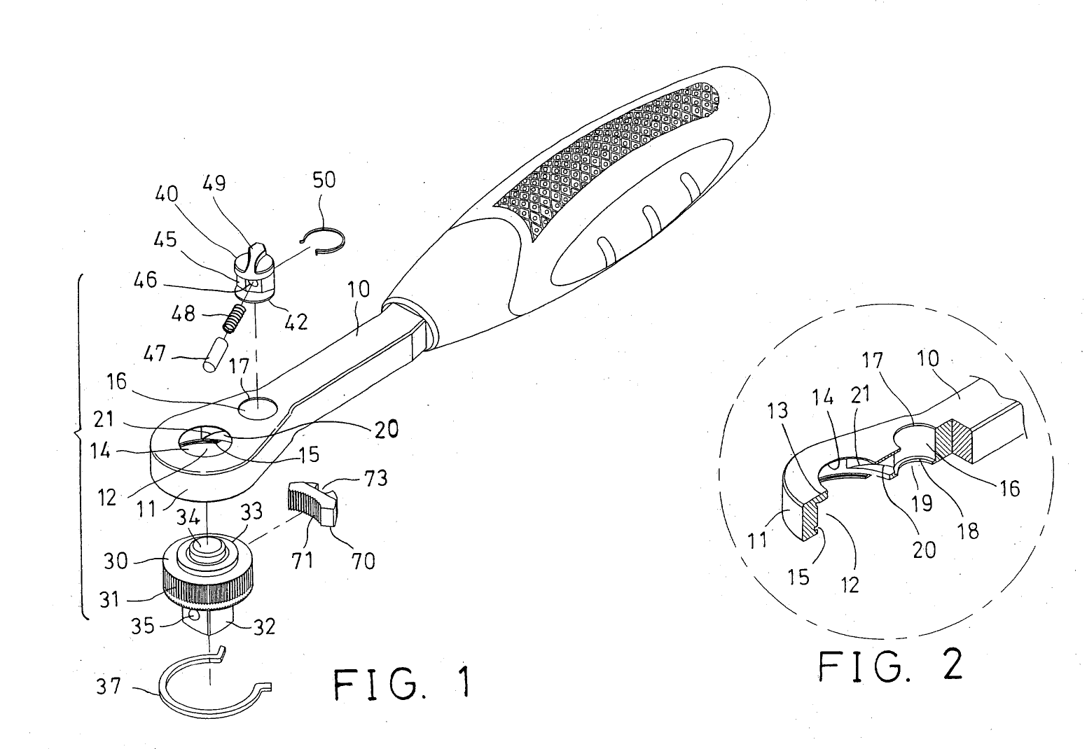

### DETAILED DESCRIPTION OF THE PREFERRED EMBODIMENT

Referring to the drawings, a ratchet driving tool in accordance with the present invention comprises a beam or a handle 10 including an enlarged head 11 formed or provided on one end thereof. The head 11 includes a chamber 12 formed therein to rotatably receive a ratchet wheel 30 therein which includes a number of ratchet teeth 31 formed or provided on the outer peripheral portion thereof.

The head 11 includes a peripheral flange 13 extended into the chamber 12 thereof from an upper portion thereof, to form an opening 14 that includes an inner diameter smaller than that of the chamber 12 of the head 11. The peripheral flange 13 of the head 11 may be engaged with the ratchet wheel 30, in order to stably and rotatably retain the ratchet wheel 30 within the chamber 12 of the head 11.

The ratchet wheel 30 includes a driving stem 32 extended downwardly therefrom and extendible downwardly out of the to chamber 12 of the head 11, and includes a circular swelling 33 extended upwardly therefrom and rotatably engaged in the opening 14 of the head 11, for stably retaining the ratchet wheel 30 within the chamber 12 of the head 11. A shank 34 is slidably engaged in the ratchet wheel 30 to actuate a typical projection 35.

The head 11 includes an inner peripheral groove 15 formed in a lower portion thereof, and communicating with the chamber 12 thereof, to receive a retaining ring 37 which may engage with the lower portion of the ratchet wheel 30, and to stably and rotatably retain the ratchet wheel 30 within the chamber 12 of the head 11. The ratchet wheel 30 may thus be easily and quickly and rotatably secured and retained within the head 11 by the retaining ring 37.

The ratchet driving tool further includes a space 16 formed in such as the handle 10 or the head 11, and having an open upper portion 17, to rotatably receive an actuator 40 therein. The head 11 or the handle 10 includes a peripheral rib 18 extended into the lower portion thereof, to form or define a smaller orifice 19 which includes an inner diameter smaller than that of the space 16 or the open upper portion 17 of the head 11 or of the handle 10.

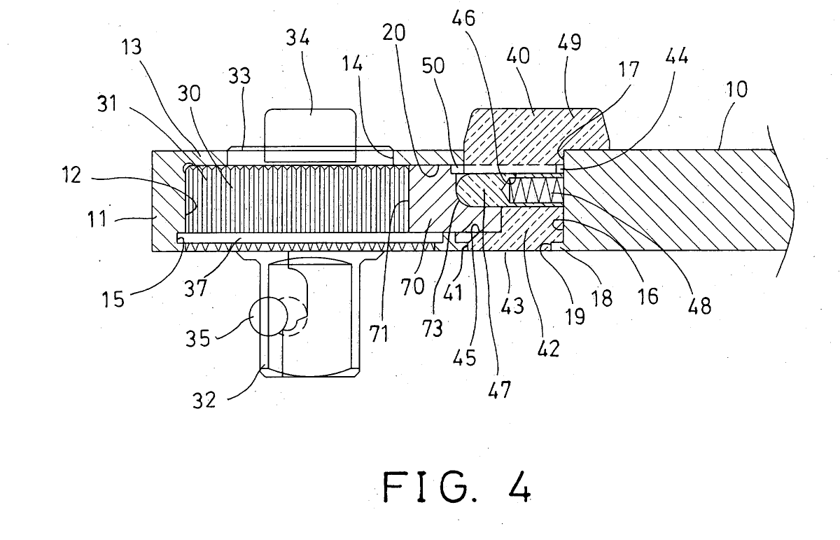

The actuator 40 includes an outer diameter arranged to be snugly or rotatably received in the space 16 of the head 11 or of the handle 10, and includes an outer peripheral shoulder 41 formed in the lower portion 42 thereof (FIG. 4) to form a circular bulge 43, and to engage with the peripheral rib 18 and the orifice 19 of the head 11 or of the handle 10 respectively, so as to rotatably retain the actuator 40 within the space 16 of the head 11 or of the handle 10.

The peripheral rib 18 of the head 111 or of the handle 10 is engaged into the outer peripheral shoulder 41 of the actuator 40, and the circular bulge 43 of the actuator 40 is engaged within the orifice 19 of the head 11 or of the handle 10, such that the actuator 40 may be stably and rotatably retained within the space 16 of the head 11 or of the handle 10.

The actuator 40 includes an inner peripheral recess 44 (FIG. 4) formed in the upper portion thereof to receive a retaining ring 50 which may engage with the head 111 or the handle 10, in order to stably and rotatably retain the actuator 40 within the space 16 of the head 11 or of the handle 10. The actuator 40 may be easily and quickly secured within the space 16 via the open upper portion 17 of the head 11 or of the handle 10 by the retaining ring 50.

The actuator 40 includes a cut-off notch 45 formed therein, and a cavity 46 laterally formed therein and communicating with the notch 45 thereof, to receive a detent 47 and a spring 48 therein, and includes a hand grip 49 formed or provided on top thereof, for rotating the actuator 40 relative to head 11 or the handle 10, and for controlling or actuating the rotational or driving direction of the ratchet driving tool.

The ratchet driving tool further includes a compartment 20 formed in such as the handle 10 or the head 11, and located between the chamber 12 of the head 11 and the space 16 of the head 11 or of the handle 10, to receive a pawl 70 therein. The pawl 70 includes one or more teeth 71 provided thereon for engaging with the ratchet teeth 31 of the ratchet wheel 30, and in order to control the rotational or driving direction of the ratchet wheel 30.

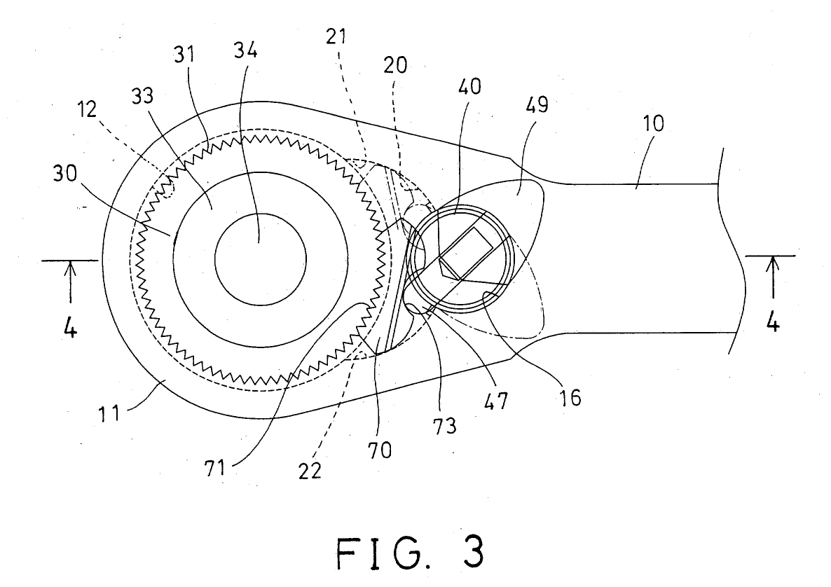

The pawl 70 includes a depression 73 to receive the detent 47. The compartment 20 of the handle 10 or the head 11 includes two narrower ends 21, 22 (FIG. 3) formed therein for retaining the pawl 70 within either of the narrower ends 21, 22 of the compartment 20 of the handle 10 or the head 11. The spring-biased detent 47 may force the pawl 70 within either of the narrower ends 21, 22 of the compartment 20 of the handle 10 or the head 11.

In assembling the ratchet driving tool, the actuator 40 may first be easily and quickly secured within the space 16 via the open upper portion 17 of the head 11 or of the handle 10 by the retaining ring 50. The pawl 70 may then be easily and quickly engaged into the compartment 20 of the handle 10 or the head 11 via the chamber 12 of the head 11. The ratchet wheel 30 may then be easily and quickly secured and retained within the head 11 by the retaining ring 37.

Accordingly, only two retaining rings 37, 50 are required to be attached to the actuator 40 and the ratchet wheel 30 and the handle 10 or the head 11, in order to easily and quickly secure and retain the ratchet wheel 30 and the actuator 40 and the pawl 70 within the chamber 12 and the space 16 and the compartment 20 of the handle 10 or the head 11. The pawl 70 may be partially received in the notch 45 of the actuator 40.

Accordingly, the ratchet driving tool in accordance with the present invention includes a simplified structure for facilitating the manufacturing and assembling of the ratchet driving tool.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A ratchet driving tool comprising:
a handle including a head provided on one end thereof, said head including a chamber formed therein, and including an upper portion having a peripheral flange extended into said chamber thereof to form an opening therein which includes an inner diameter smaller than that of said chamber of said head, said head including an inner peripheral groove formed therein and communicating with said chamber thereof,
a ratchet wheel rotatably received in said chamber of said head, and including a plurality of teeth provided thereon, and including a swelling extended therefrom and rotatably engaged in said opening of said head to stably retain said ratchet wheel within said chamber of said head,
a retaining ring engaged in said inner peripheral groove of said head, and engaged with said ratchet wheel, and to stably and rotatably retain said ratchet wheel within said chamber of said head,
said handle including a space formed therein and having an open upper portion and having a lower portion, and a peripheral rib extended into said lower portion of said space of said handle, to form an orifice therein, said orifice including an inner diameter smaller than that of said space and said open upper portion of said space of said handle,
an actuator rotatably received in said space of said handle, and including a lower portion having an outer peripheral shoulder formed therein to receive said peripheral rib of said handle, and to form a circular bulge which is rotatably engaged into said orifice of said handle, to rotatably retain said actuator within said space of said handle, said actuator including a hand grip provided on top thereof for rotating said actuator relative to said handle,
said head including a compartment formed therein and formed between said chamber of said head and said space of said handle, and having two narrower ends provided therein,
a pawl slidably received in said compartment of said head, and including a plurality of teeth for engaging with said teeth of said ratchet wheel, and including a depression formed therein,
said actuator including a cavity formed therein, and
a spring-biased detent received in said cavity of said actuator, and engaged within said depression of said pawl, to force said pawl to either of said narrower ends of said compartment of said head, when said actuator is rotated relative to said handle with said hand grip of said actuator.

2. The ratchet driving tool as claimed in claim 1, wherein said actuator includes a notch formed therein and communicating with said cavity thereof to partially receive said pawl.

3. The ratchet driving tool as claimed in claim 1, wherein said actuator includes a spring received in said cavity thereof to engage with and to bias said detent to force said pawl to either of said narrower ends of said compartment of said head.

4. The ratchet driving tool as claimed in claim 1, wherein said actuator includes an upper portion having an inner peripheral recess formed therein, and a second retaining ring engaged in said inner peripheral recess of said actuator, and engaged with said handle, to stably retain said actuator within said space of said handle.
